(19) United States
(12) Patent Application Publication
(10) Pub. No.: US 2003/0070753 A1
(43) Pub. Date: Apr. 17, 2003

(54) Heat-sensitive stencil sheet and method of making the same

(75) Inventor: Hideyuki Yamaguchi, Numazu-shi (JP)

Correspondence Address: RICHARD F. JAWORSKI, Cooper & Dunham LLP, 1185 Avenue of the Americas, New York, NY, 10036, US

(73) Assignee: Ricoh Company, Ltd.

(21) Appl. No.: 10/075,481

(22) Filed: Feb. 13, 2002

(30) Foreign Application Priority Data
Feb. 14, 2001 (JP) P2001-037626
Jul. 10, 2001 (JP) P2001-208939
Jan. 25, 2002 (JP) P2002-017757

(51) Int. Cl. C09J 5/02

(52) U.S. Cl. 156/307.3; 156/307.7; 428/343

(57) ABSTRACT

A stencil having a porous resin layer provided on one side of a thermoplastic resin film, and a porous fiber layer bonded by an adhesive to the surface of the porous resin layer, wherein the bonding between the thermoplastic resin film and the porous fiber layer is performed by using the amount of the adhesive in a determined amount ranges from 0.05 g/m² to 15.0 g/m² by dry basis, so that an interruption of the passing-through the layers by printing ink is eliminated, and a desired degree of the bonding strength to inhibit an undesirable expansion or breaking-down of the printing stencil is ensured.

### BACKGROUND OF THE INVENTION

1. Field of the Invention

The present invention relates to a heat-sensitive stencil sheet to be perforated by irradiation of infrared light or flash light from a halogen lamp, a xenon lamp, or a flash bulb, pulsed irradiation of laser light, or heat irradiation from a thermal head, and a method for producing the same.

2. Description of the Related Art

Heretofore, heat-sensitive stencil sheets used in practice have been manufactured by bonding an ink-transmissible supporting substrate, which is a sheet of porous tissue paper made of natural fiber, synthetic fiber, or their mixture, to a thermoplastic film by using an adhesive.

Such stencil sheet having a sheet of fabric-based porous tissue paper as the supporting substrate however has the following drawbacks.

(1) For bonding the porous tissue paper to a plastic film, adhesive is usually used, which tends to be trapped between fibers of the porous tissue paper, acting as water bird webs. The webs of the adhesive may disturb the perforating effect by using the thermal head, inhibiting the passing through of ink, thus causing printing dapples or voids.

(2) Fibers par se of the porous tissue paper may disturb the passing-through of ink, causing printing dapples or voids.

(3) As the fibers of the porous tissue paper disturb the smoothness of the film surface, and thereby, a contacting to the surface of thermal head becomes not closely and insufficient, thus generating perforation errors and causing printing dapples or voids.

Some improvements for overcoming above drawbacks have been introduced with little success. For example, Japanese Unexamined Patent Publication of Tokkai Hei 3-193445 discloses a tissue paper sheet for use as a porous supporting substrate made of synthetic fiber which has a fineness diameter like as one denier degree or less, however, this paper sheet is hardly effective for eliminating the drawbacks. Also, disclosed in Japanese Unexamined Patent Publication of Tokkai Shou 62-1984459 concerns with a method for forming of a porous substrate, in the method, a substantially closed pattern of a resinous ink, which is a radiation-curable, is printed onto thermoplastic film by using gravure, offset, or flexograph technique. This method is however found difficult to create each line smaller than 50 μm wide of the resin pattern, thus hardly creating perforations and causing the printing dapples.

Furthermore, disclosed in Japanese Unexamined Patent Publication of Tokkai Hei 3-240596 is a printing method, in which a liquid dispersion comprising water-dispersible polymer and colloidal silica is applied onto the surface of a thermoplastic film and is dried, then a porous supporting substrate is applied onto the coated surface of the thermoplastic film which is then perforated to utilize it for ink jet printing with a low viscous ink. The porous supporting substrate is however very small in the diameter of pores and can hardly allow common stencil (mimeograph) ink to pass-through, thus declining the density of printed by the ink. Disclosed in Japanese Unexamined Patent Publication of Tokkai Sho 54-33117 is a heat-sensitive stencil sheet which consists substantially of thermoplastic film only, therefore it does not intend to be assisted by porous supporting substrate. This heat-sensitive stencil sheet has a high margin in the thermal shrinkage, it may favorably be perforated by using a thermal head when the thickness thereof is not greater than 3 μm, thus may realize a high quality of prints. However, the heat-sensitive stencil sheet lacks the physical stiffness and makes troubles when being conveyed. If the heat-sensitive stencil sheet increases the thickness thereof, the perforating performance by using a thermal head will be declined, hence causing printing dapples.

Moreover, another attempt for increasing the ease of perforation is an application of a micro-porous layer of adhesive in which a micro-porous resin material is included (as disclosed in Japanese Unexamined Patent Publication of Tokkai Hei 9-52469. However, in this case, the adhesive as micro-porous layer is almost simultaneously bonded to a porous supporting substrate, or bonded as soon as after ended coating thereof, by using a wet laminating technique, to effect the bonding, without time lapse for drying the coated micro-porous layer, by nature of the wetted technique. However, it may hardly develop micro pores. Also this porous supporting substrate tends to occur the voids in a solidly printed area, because of owing to the fibers liberated by the influence of adhesive.

Further also there is proposed a heat-sensitive stencil sheet which has a porous resin layer provided on one side of a thermoplastic film (as disclosed in Japanese Patent 2612266 and Japanese Unexamined Patent Publication of Tokkai Hei 11-309954. The porous resin layer is provided on one side of the thermoplastic film directly, but is not provided through an interposed porous layer.

We have proposed heat-sensitive stencil sheets having a porous resin layer provided on one side of a thermoplastic film (as disclosed in Japanese Unexamined Patent Publications of Tokkai Hei 8-332785, Tokkai Hei 10-24667, and Tokkai Hei 11-235885. However, it is difficult to hold them in high level of stiffness by mean of the resin layer only, hence they were likely to generate the wrinkles when being conveyed in a printing machine.

For overcoming this disadvantage, we have proposed improved heat-sensitive stencil sheets which are constructed by applying a porous resin layer onto one side of a thermoplastic resin film then applying a porous fiber layer of a fabric material onto the upper surface of the porous resin layer, as disclosed in Japanese Unexamined Patent Publications of Tokkai Hei 10-147075 and Tokkai Hei 10-236011. Those heat-sensitive stencil sheets have been developed by the basis of an idea of function-sharing upon the porous supporting substrate of conventional heat-sensitive stencil sheet. In other words, the porous resin layer has a role to control the ink supply in the heat-sensitive stencil sheet, on the other hand, the porous fiber layer has a role to hold the heat-sensitive stencil sheet in an appropriate level of stiffness and strength required for making ease of conveyance and improving the durability.

The latter, disclosed in Japanese Unexamined Patent Publication of Tokkai Hei 10-236011 concerns with a heat-sensitive stencil sheet which has a porous fiber layer being bonded by mean of a porous resin layer as an adhesive layer during fabricating thereof. This heat-sensitive stencil sheet may be disturbed in the development of the porosity of the porous layers, hence an unfavorable quality of the porous layers.

The former, disclosed in Japanese Unexamined Patent Publication of Tokkai Hei 10-147075 concerns with a heat-sensitive stencil sheet in which a porous resin layer and a porous fiber layer being bonded to each other by an adhesive. The adhesive, when having a high viscosity permits the two porous layers to bond together, without disturbing their porosity. The adhesive of a polyethylene thermoplastic type disclosed in the embodiment has to be applied in a larger amount for providing a bonding strength between the porous resin layer and the porous fiber layer enough to resist against the printing action. This may decline the passing-though of ink. If the amount of the adhesive is decreased for improving the ability to make passing-through of ink, the porous resin layer and the porous fiber layer may possibly be separated from each other during the printing operation, causing a broke down of the heat-sensitive stencil sheet itself.

### SUMMARY OF THE INVENTION

Therefore, it is an object of the present invention to provide a heat-sensitive stencil sheet which comprises a porous resin layer of a resin material provided on the surface of one side of thermoplastic resin film, and a porous fiber layer of fabric material provided on the porous resin layer, wherein the bonding between the porous resin layer and the porous fiber layer is conducted by such an amount of adhesive that printing ink can be passed through the layers without interruption, while ensuring a desired degree of the bonding strength, thereby the heat-sensitive stencil sheet has a supporting substrate therefor to inhibit an undesirable expansion or breaking-down of the heat-sensitive stencil sheet.

It is another object of the present invention to provide a method of making said heat-sensitive stencil sheet.

The heat-sensitive stencil sheet and the method of making it according to the present invention also can produce the prints which have less dapples, smears, and blurs with the use of a smaller amount of printing ink.

Inventors have studied on the bonding between the porous resin layer and porous fiber layer, and found that the multi-layers configuration of the heat-sensitive stencil sheet of the present invention, in which a thermoplastic resin film and a porous resin layer are adjacent each other, and a porous fiber layer is provided at the reverse side of the porous resin layer, thereby, with regard to the bonding between both the porous resin layer and the porous fiber layer, which is a major feature of the present invention, it can hardly interrupt the porosity and can hardly clog the pores in the porous resin layer thus exhibits a proper degree of the bonding strength enough to maintain no peeling-off during the printing action, unlike the bonding between thermoplastic resin film and porous fiber layer in the prior art. The present invention has developed depending upon the basis of such facts.

The term “porous resin layer” used herein means a porous layer of the foamy shape assembly, which is, for example but not for restriction, produced by depositing a resin from a solution or dispersion of the resin by using a solvent, or solvents including water and by other suitable methods, and includes a multiplicity of wall 2a which defines cells equipped with ceilings 2b with adhesive 3, assuming that the surface of the film 1 is a floor, the porous resin layer 2 being bonded with the porous fiber layer 4, as instanced in FIG. 1, a honey combed structure equipped with walls 2b instead of the ceilings, and with the exception of the floor, as instanced in FIG. 2, a group of foamy-like cells as instanced in FIG. 3 is an assembly of granular-shaped or fabric-shaped resin segments pieces 2b coupled together, instead of the ceilings and walls, as instanced in FIG. 4, and the like. However the porous resin layer is not restricted to these instructions.

Average diameter of the pores of the above mentioned porous resin layer is possible to be a smaller than that of conventional porous supporting substances consisting of fiber materials, and especially, a range from 5 μm to 20 μm of average pore size is particularly excellent for dispersing a W/O-type (water in oil type) emulsion ink which is used for general stencil printing or in other words mimeo graph printing, thus a high quality print with a excellent solid area is obtained.

In the depth direction of the layer, each pore in the porous fiber layer are connected each other, while in the traverse direction of the layer, the each pore are hardly connected, thereby sideward deviated penetration of the ink in heat-sensitive stencil sheet is decreased. Accordingly, by mean of the porous resin layer, it is possible to suppress a transmitting of the excess ink. Thereby, in comparison with conventional supporting substrates which have almost same average size of pores as that of the present invention, so-called set off can be avoided more effectively.

With regard to formulation of the porous resin layer, in view of ink dispersibility, the most favorable one is an assembly of cells having honey combed structure. However in view of manufacturing, a favorable is a foamy film formed by applying a fluid containing a W/O-type emulsion as main ingredient onto a thermoplastic film and drying it, because it is producible a stable coating, and if desired, the foamed structure can be altered to the another structure of more similar to honey combed one.

The term “porous fiber layer” used herein means a porous layer assembly formed by piling up of fibrous materials, or constituted by fiber members 4a, in a mode having space parts 4b, as instanced in FIG. 5.

This porous fabric layer is almost same as conventional porous supporting substrate in the structure. However this porous fabric layer has a special feature that gives higher mechanical strength than that by the porous resin layer, with ease. Average size of pores of the porous fabric layer is depended upon the thickness, weight of used fibers, and the like, thus it is bigger than that of above mentioned porous resin layer, and in general, it ranges between about 25 μm to 60 μm.

Thus, the above objects of the present invention are achieved by: (1) a heat-sensitive stencil sheet having a porous resin layer provided on one side of a thermoplastic resin film, and a porous fiber layer bonded by an adhesive to the surface of the porous resin layer, wherein the amount of the adhesive ranges from 0.05 g/m² to 1.5 g/m², and the bonding strength between the porous resin layer and the porous fiber layer ranges from 0.8 N/m to 50.0 N/m;

(2) a heat-sensitive stencil sheet according to the paragraph (1), wherein the adhesive is a primarily urethane adhesive of a moisture-curable type; and

(3) a heat-sensitive stencil sheet according to the paragraph (1), wherein the adhesive is a primarily adhesive of ionizing radiation-curable type.

Also, the objects of the present invention are achieved by: (4) a heat-sensitive stencil sheet according to the paragraphs (1), wherein the amount of the porous resin layer ranges from 0.5 g/m²to 10 g/m² by dry basis;

(5) a heat-sensitive stencil sheet according to the paragraphs (1), wherein the amount of the porous resin layer ranges from 1.0 g/m²to 5.0 g/m² by dry basis;

(6) a heat-sensitive stencil sheet according to the paragraphs (1), wherein the porous resin layer is a foamy film having been formed by the application of a fluid containing a resin emulsion of W/O (water in oil) type onto a thermoplastic film and drying;

(7) a heat-sensitive stencil sheet according to the paragraphs (1), wherein the amount of the porous fiber layer ranges from 1.0 g/m²to 15.0 g/m²; and

(8) a heat-sensitive stencil sheet according to the paragraphs (1), wherein the amount of the porous fiber layer ranges from 3.0 g/m²to 10.0 g/m².

Moreover, the objects of the present invention are achieved by: (9) a method of fabricating a heat-sensitive stencil sheet according to any one of the paragraphs (1) to (8), comprising steps of; applying a coating liquid to one side of a thermoplastic film to form a porous resin layer attached thereto; and after at least the outermost surface of the porous resin layer is dried and cured, bonding the porous resin layer to a porous fiber layer being coated with a adhesive;

(10) a thermal stencil printing method using a perforated heat-sensitive stencil master produced from a heat-sensitive stencil sheet, wherein, as the heat-sensitive stencil sheet, a heat-sensitive stencil sheet according to any one of the paragraphs (1) to (8) is employed, and which is subjected to the steps comprising; applying thermal energy in a pattern wise thereby perforating a pattern assembly of ink-transmissible pores to produce the perforated heat-sensitive stencil master; then through the perforated heat-sensitive stencil master, applying ink to a surface to be printed.

Furthermore, the objects of the present invention are achieved by: (11) a thermal stencil printing apparatus loaded with a perforated heat-sensitive stencil master produced from a heat-sensitive stencil sheet, wherein the heat-sensitive stencil sheet is one as according to any one of the paragraphs (1) to (8); and,

(12) a thermal stencil printing apparatus according to the paragraph (11) which includes; a porous printing drum, on which a heat-sensitive stencil sheet is set; an ink-feeding means for feeding printing ink into an ink-feeding region located at the back of a porous inner surface of the printing drum, the inner surface defines the cavity periphery of the printing drum, the ink-feeding region is faced to a pressuring portion of outer surface of the printing drum, and to the pressuring portion is applied a pressure called printing pressure during printing; a printing drum-pressing means driven from non contact location thereof to contact location thereof in the cavity of the printing drum to discharge the printing ink from the inside to the outside of the printing drum; and a printing paper-conveying means for conveying printing paper to the pressuring portion of outer surface of the printing drum.

### BRIEF DESCRIPTION OF THE DRAWINGS

FIG. 1 is a schematic cross sectional view of one embodiment of a heat-sensitive stencil sheet according to the present invention;

FIG. 2 is a perspective view of another embodiment of a heat-sensitive stencil sheet according to the present invention;

FIG. 3 is a schematic cross sectional view of a further embodiment of a heat-sensitive stencil sheet according to the present invention;

FIG. 4 is a schematic cross sectional view of a still further embodiment of a heat-sensitive stencil sheet according to the present invention;

FIG. 5 is a schematic cross sectional view of a embodiment of porous fiber layer constituting a heat-sensitive stencil sheet according to the present invention;

FIG. 6 is an electron microscope photo showing a laminated web having a porous resin layer bonded by an adhesive to a porous fiber layer according to the present invention (with the film having been removed from the porous resin layer);

FIG. 7 is an electron microscope photo showing a laminated web having a porous resin layer bonded by an adhesive to a porous fiber layer according to the present invention (with the film having been removed from the porous resin layer); and

FIG. 8 is a view of a thermal stencil printing machine showing one embodiment of the present invention.

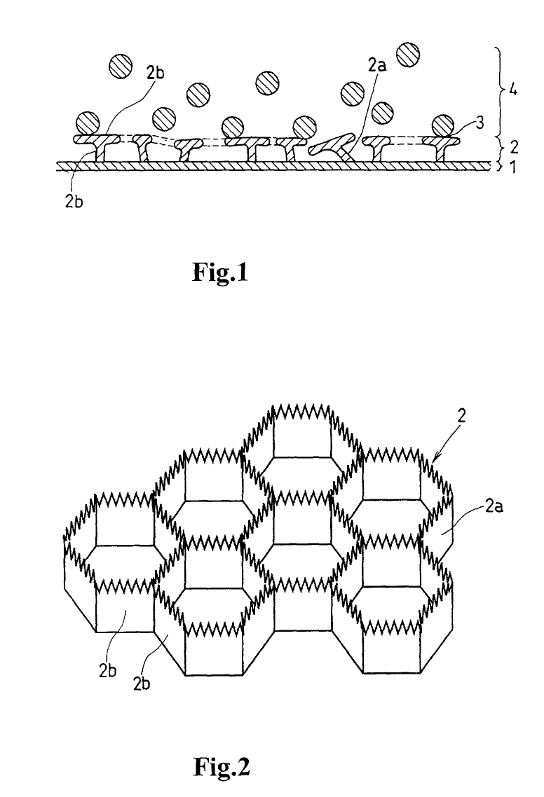

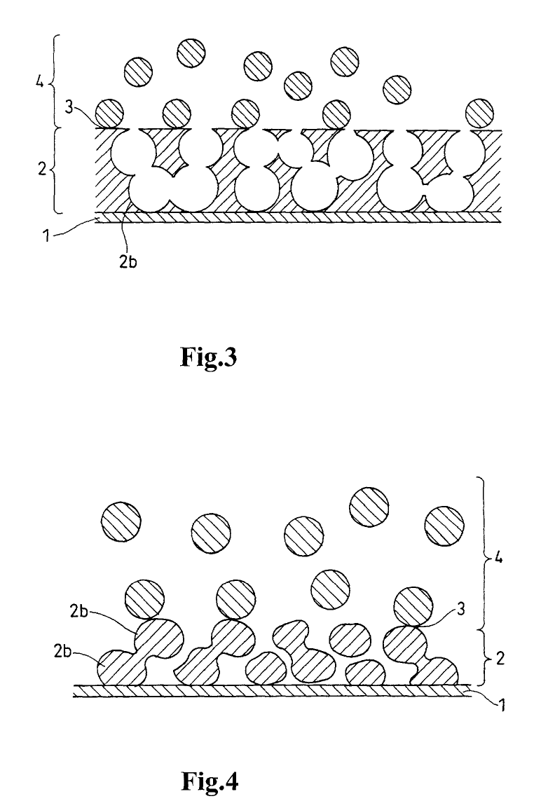

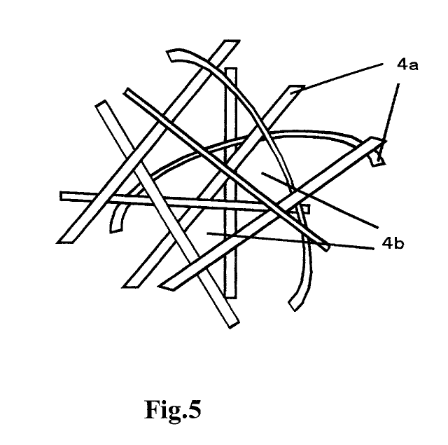

### DETAILED DESCRIPTION OF THE PREFERRED EMBODIMENTS

The present invention will now be described in more detail below.

As shown above, according to the first aspect of the present invention, there is provided a heat-sensitive stencil sheet having a porous resin layer provided on one side of a thermoplastic resin film and a porous fiber layer bonded by an adhesive to the surface of the porous resin layer, wherein amount of the adhesive is in the range from 0.05 g/m² to 1.5 g/m².

Discoveries as denoted below have now been given through various experiments in the present invention. Namely, a porous resin layer and a porous fiber layer, which both layers are highly porous for allowing printing ink to pass, are bonded to each other by an adhesive in a heat-sensitive stencil sheet, thereby an excess of the adhesive, which may interrupt to pass-through of printing ink, can be avoided. When the amount of the adhesive used is too small, uniform coating will hardly be implemented thus causing unwanted results of de-lamination or peeling off of the porous resin layer and the porous fiber layer from each other, during conveying or printing action are effecting. In the present invention, the amount of the adhesive ranges preferably from 0.05 to 1.5 g/m², more preferably from 0.1 to 1.0 g/m², and most preferably from 0.15 to 0.8 g/m². Also, to cope with the problems of de-lamination and peeling off of the porous resin layer and the porous fiber layer from each other, during the conveying or printing action being imposed, the bonding strength was recognized as important and has been deeply studied to inhibit such separation. The bonding strength in the present invention may preferably be larger than or equal to 0.8 N/m and more preferably larger than or equal to 1.6 N/m. If the bonding strength is smaller than 0.8 N/m, the separation of the porous resin layer and the porous fiber layer from each other may occur during the handling or conveying action being imposed, thus resulting the generation of wrinkles as well as expansion or stretching, peeling-off, and breakage. The upper limit of the bonding strength may substantially depend upon the bonding strength between any two adjacent layers via the porous resin layer because it is saturated when the bonding strength between the porous resin layer and the porous fiber layer exceeds the intra-layer bonding strength. In general, the level of the strength is not greater than 50 N/m. A bonding strength between the porous resin layer and the thermoplastic resin film is also another consideration and may preferably be larger than or equal to 0.8 N/m. If smaller than 0.8 N/m, similar described troubles will occur. It is then found through a series of experiments that the bonding strength between the porous resin layer and the porous fiber layer stays in a favorable range of 0.8 to 50.0 N/m when the amount of the adhesive ranges from 0.05 to 1.5 g/m².

The experiments were carried out by the following manners.

1) Measurement of the Amount of Adhesive

A difference in the weight between a piece size of 25×25 cm, of the porous fiber layer coated with the adhesive and dried, and a piece size of 25×25 cm, of the porous fiber layer non-coated is calculated and converted into a measurement in g/m² which is designated as the amount of the adhesive.

2) Measurement of the Bonding Strength

(i) Bonding Strength Between the Thermoplastic Resin Film and the Porous Resin Layer

The porous fiber layer is removed from the heat-sensitive stencil sheet and, to the removed side of the porous resin layer, a length of Cellophane Tape (Registered Trademark, Nichiban Co., Ltd., Japan) is air-tightly bonded. Then, the bonding strength is measured by a 90-degree peel test conforming to JIS (Japanese Industrial Standard) K6854-1. At the time, while the porous resin layer on which is bonded by the Cellophane Tape is maintained stationary, the thermoplastic resin film is pulled off. If the porous fiber layer is hardly removed, no Cellophane Tape is applied and both the porous fiber layer and the porous resin layer are held stationary as a single unit each other during the measurement. A test sample is 25 mm in width and the bonding strength per meter is expressed in N/m.

(ii) Bonding Strength Between the Porous Resin Layer and the Porous Fiber Layer

The thermoplastic resin film is removed from the heat-sensitive stencil sheet and a length of Cellophane Tape is air-tightly bonded to the thermoplastic resin film at removed side of the porous resin layer. Then, the bonding strength is measured by the 90-degree peel test conforming to JIS K6854-1. At the time, while the porous resin layer on which the Cellophane Tape is bonded remains stationary, the porous fiber layer is pulled off. If the thermoplastic resin film is hardly removed, no Cellophane Tape is applied and both the thermoplastic resin film and the porous fiber layer are retained as a single unit during the measurement. A test sample is 25 mm in width and the bonding strength per meter is expressed in N/m.

The feature represented by above paragraph (1) of the present invention may advantageously be implemented by the feature represented by above paragraph (2) of the present invention wherein the adhesive used primarily is a moisture-curable of polyurethane adhesive. The term “primarily” indicates the amount required effecting the curing action readily and steadily, by a urethane component in the polyurethane adhesive enough. Although depending significantly upon the other ingredients such as a filler and the curing conditions, the amount of the urethane component in the polyurethane adhesive is preferably 40% when having been cured.

It is found through experiments that among the adhesives to establish the bonds between them and many kinds of fibrous materials, the moisture-curable type polyurethane adhesive is most favorable to provide a desired degree of the bonding strength with the smaller amount, in the case where the porous resin layer is selected from vinyl resins such as polyvinyl acetate, polyvinyl butyral, vinylchloride-vynilacetate copolymer, vinylchloride-vinylidenechloride copolymer, vinylchloride-acrylonitrile copolymer, and styrene-acrylonitrile copolymer, polybutylene, polyamide such as nylon, polyphenylene oxide, (metha)ester acrylate, polycarbonate, polyurethane, cellulose derivatives such as acetyl cellulose, acetylbutyl cellulose, and acetylpropyl cellulose, and where the porous fiber layer is selected from (i) mineral fibers such as glass, sepiolite, and other metals, (ii) animal fibers such as wool and silk, (iii) natural fibers such as cotton, Manila hemp, mulberry, mitsumata, and pulp,(iv) recycled fibers such as staple yarn and rayon, (v) synthetic fibers such as polyester, polyvinyl alcohol, and acryl polymer, (vi) semi-synthetic fibers such as fiber carbon, and (vii) inorganic fibers such as whisker, and the like. This effect may be derived from some factors and may significantly be based upon the chemical bonding strength developed by reaction between water applied on the layer surface and isocyanate contained in the moisture-curable type polyurethane adhesive according to the present invention

The moisture-curable type polyurethane adhesive may be selected from, but not limited to, comprehensive type (one part type) of urethane pre-polymer of moisture-curable type produced by reaction between polyols having hydroxide radicals at both ends (such as polyester polyol, polyether polyol) and isocyanate, and separated type of adhesive consisting of polyol ingredient and isocyanate ingredient separated from each other. The isocyanate may be includes aliphatic or cycloaliphatic diisocyanates such as hexamethyl-diisocyanate (HMDI), 2,4-diisocyanate-1-metylcyclohexane, 2,6-diisocyanate-1-metylchclohexane, diisocyanate cyclobutane, tetramethylene-diisocyanate, O-, m-, and p-xylene diisocyanates (XDI), dicyclohexyl-methane-diisocyanate, dimethyl-dicyclohexylmethane-diisocyanate, hexahydromethaxylidene-diisocyanate (HXDI), and lysine-diisocyanate-alkylesters (where alkyl contains preferably 1 to 6 carbon atoms), aromatic diisocyanates such as toluylene-2,4-diisocyanate (TDI), toluylene-2,6-diisocyanate, diphenyl methane-4,4′-diisocyanate (MDI), 3-methyldiphenylmethane4,4′-diisocyanate, m- and p-phenylene-diisocyanates, chlorophenylene-2,4-diisocyanate, naphthalene-1,5-diisocyanate, diphenyl-4,4′-diisocyanate, 3,3′-dimethyldiphenyl-4,4′-diisocyanate, 1,3,5-triisopropylbenzene-2,4-diisocyanate, and diphenylether-diisocyanate, and combination thereof.

When the moisture-curable type urethane adhesive is used, the curing action may preferably be intended for accelerating the reaction of the heat-sensitive stencil sheet provided in a roll form. The curing temperature is preferably below than or equal to 50° C. and more preferably less than or equal to 40° C. If higher than 50° C., the thermoplastic resin film may be shrunk and curled. Hence, the curing action is not limited to a given period of time but may be lasted until a desired degree of the bonding strength is obtained.

The heat-sensitive stencil sheet defined in the paragraph (1) of the present invention may advantageously be implemented by the features represented by paragraph (3) and other paragraphs of the present invention wherein the curable adhesive is primarily an ionizing radiation-curable type. According to this feature of the present invention, a desired degree of the bonding strength can be obtained with a minimum of the adhesive like the moisture-curable type polyurethane adhesive. In particular, the period required for the curing action can significantly be reduced.

The ionizing radiation-curable type adhesive may include polymer having radical polymeric double-bonds, containing mono-functional monomer or multi-functional monomer such as polyester, polyether, acryl resin, epoxy resin, and urethane resin which have relatively low molecular weight and are radically reactive with (meth)acrylates, and are capable of polymeric cross-linking by means of electrons or ultraviolet light, if desired, it further may containing a photo-polymerization initiator. Any known ionizing radiation-curable type adhesive may be used in the heat-sensitive stencil sheet of the present invention. Preferably, the ionizing radiation-curable type adhesive may contain urethane acrylate oligomer for improving the bonding strength and the elasticity simultaneously.

The urethane acrylate used according to the present invention may be produced from multivalent alcohols, multivalent isocyanates, and hydroxide acrylates.

Characteristic examples of the urethane acrylate are instanced as an addition reaction products of organic polyacid (such as adipic acid, sebacic acid, maleic acid, terephthalic acid), multivalent alcohol (such as ethylene glycol, propylene glycol, 1,4-butylene glycol, 1,6-hexanediol), diisocyanate (such as tolylene diisocyanate, 4,4′-diphenylmethane diisocyanate, hydrogenated tolylene diisocyanate, isophorone diisocyanate, 1,6-hexamethylene diisocyanate), and 2-hydroxyethyl acrylate; or, an addition reaction products of polyester-diol (such as polyethylene glycol, polypropylene glycol, polytetramethylene glycol), diisocyanate (such as tolylene diisocyanate, 4,4′-diphenylmethane diisocyanate, hydrogenated tolylene diisocyanate, isophorone diisocyanate, 1,6-hexamethylene diisocyanate), and 2-hydroxyethyl acrylate.

Characteristic examples of the mono-functional monomer are vinyl monomers including (meth)acrylic esters, (meth)acryl amides, aryl compounds, vinyl ethers, vinyl esters, vinyl heterocyclic compound, N-vinyl compound, styrene, (meth)acrylic acid, crotonic acid, itaconic acid, and other vinyl monomers. Characteristic examples of the multi-functional monomer are instanced as diethylene glycol di(meth)acrylate, triethylene glycol di(meth)acrylate, tetraethylene glycol di(meth)acrylate, trimethylol propane tri(meth)acrylate, pentaerythlytol tetra(meth)acrylate, dipentaerythlytol hexa(meth)acrylate, and tris(β-(meth)acryloiroxyethyl) isocyanurate.

Characteristic examples of the photo polymerization initiator are, as mono-functional types, 2-ethylhexyl acrylate, 2-hydroxyethyl acrylate, 2-hydroxypropyl acrylate, 2-hydroxyethyl acryloil phosphate, tetrahydrofurfuryl acrylate, and tetrahydrofurfuryl derivative acrylate, and as multi-functional types, dicyclopentenyl acrylate, dicyclopentenyl oxyethyl acrylate, 1,3-butanediol diacrylate, 1,4-butanediol diacrylate, 1,6-hexanediol diacrylate, diethylene glycol diacrylate, neopentyl glycol 400 diacrylate, polyethylene glycol 400 diacrylate, hydroxyesterpivalylate neopentyl glycol diacrylate, tripropylene glycol diacrylate, 1,3-bis(3′-acryloxyethoxy-2′-hydroxypropyl)-5,5-dimethylhydantoin, hydroxyesterpivalylate neopentyl glycol derivative diacrylate, and dipentaerythlyrol hexacrylate.

The ionizing radiation-curable adhesive may be cured when irradiated by ionizing radiation ray from the thermoplastic resin film side or the porous fiber layer side during or after the laminating action to complete the heat-sensitive stencil sheet of the present invention. It is preferable for increasing the effectiveness to apply the ionizing radiation ray from the porous fiber layer side.

The ionizing radiation ray is preferably selected from electron beam that is favorable one and ultraviolet ray. However, by adding of the photo-polymerization initiator, the ultraviolet ray may be used.

The radiation may be implemented by any known manner. For example, when the radiation of electrons is used for curing, the energy strength thereof ranges from 50 to 1000 k eV or preferably 100 to 300 k eV, which is attained by using electron accelerator as its source selected from Cockcroft-Walton type, Van de Graaff type, resonance transformer type, insulated core transformer type, linear type, electro-curtain type, Dynamitron type, high frequency type, and the like.

When the ultraviolet ray is used for curing, its radiation source is preferably selected from ultra-high-voltage mercury lamp, high-voltage mercury lamp, low-voltage mercury lamp, carbon arc lamp, xenon lamp, and metal halide lamp. For increasing the curing speed, either a metal halide lamp or a no-electrode discharge lamp D bulb is more preferably used which emits a continuous wavelength between 320 to 450 nm.

However, there is anxious that the radiation may increase the ambient temperature and cause shrinkage of the thermoplastic resin film. It is hence desired to provide a cooling apparatus.

In the present invention, the ionizing radiation-curable adhesive is sandwiched by the porous fiber layer and porous resin layer, as those both layers are poor in light-transmittance, it is favorable to use the radiation of electron beam is favorably used for curing the adhesive.

As the fourth feature of the present invention, a method of fabricating a heat-sensitive stencil sheet as defined in any one of the paragraphs (1) to (8) is provided, which comprises the steps of: applying a liquid coating on one side of the thermoplastic film to develop the porous resin layer; and after at least the outermost surface of the porous resin layer is dried and cured, bonding the porous resin layer to the porous fiber layer coated with the adhesive.

For eliminating a suppression of porosity grow in the porous resin layer during developing of bonding between the porous resin layer and the porous fiber layer, it is preferably that the applied porous resin layer in a liquid form onto one side of the thermoplastic resin film is firstly dried to form the outermost surface of the porous resin layer, then, the cured porous resin layer is bonded by adhesive provided on the porous fiber layer. More preferably, when the porous resin layer has been completed, it is bonded.

It is also desired to apply the adhesive to the porous fiber layer so as not to plug or block up the pores in the porous resin layer. Although the adhesive when cured is shrunk and its volume is decreased, proportions of both shrinkage and volume decreasing are not significant. It is rather difficult to re-open the pores once blocked up, by only contraction effect resulting from curing.

A favorable adhesive has a high viscosity so that it hardly enter into the pores of the porous resin layer during and after bonding between the porous resin layer and the porous fiber layer. The viscosity is preferably higher than or equal to 300 cps before the adhesive is fully cured and more preferably higher than or equal to 500 cps. If the viscosity is lower than 300 cps, the adhesive may enter and block the pores in the porous resin layer even after bonding, thus inhibiting the passing-through of printing ink.

If the adhesive has a viscosity of higher than 3000 cps when applied to the porous fiber layer, it may trigger the removal of fibers from the porous fiber layer, thus generating defectives. It is hence desired to lower the viscosity up to 3000 cps by heating of coating rolls.

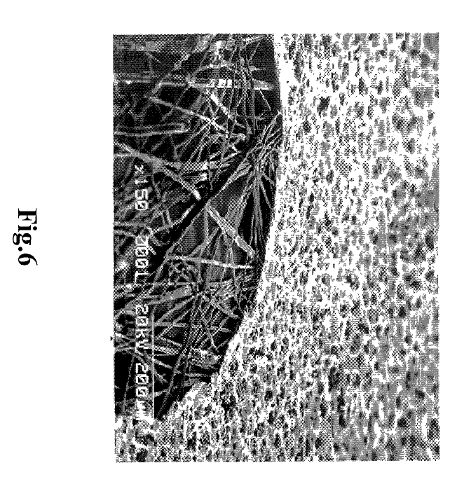

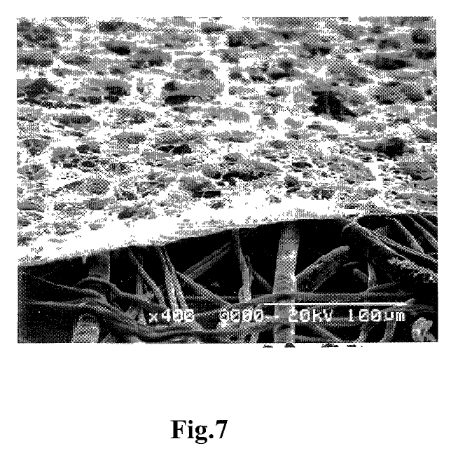

As the adhesive having an appropriate level of viscosity is applied to the porous fiber layer, it remains only on the surface of the porous fiber layer thus initiating the bonding without interrupting the passing-through of printing ink (as shown in electron microscope photos in FIGS. 6 and 7). As shown, the adhesive appears in so-called point bonding (or can say as spot-bonding).

Alternatively, the adhesive may be applied for bonding the porous resin layer to the porous fiber layer, which has been coated with an assistant agent diluted with an organic solvent such as ethyl acetate and dried. It is however desired to use no such assistant agent in view of the environmental protection and the environmental pollution with the remaining agent.

The method for applying adhesive may include, but not limited to, blade coating, reverse roll coating, gravure coating, knife coating, spray coating, offset gravure coating, kiss coating, bar coating, and roll coating techniques.

The materials in the present invention will now be specified below.

The thermoplastic resin film may be selected from known polyester, polyamide, polypropylene, polyethylene, polyvinyl chloride, polyvinylidene chloride, and their copolymer. Preferably, polyester film is employed for favorable sensitivity in perforating.

Characteristic examples of the polyester film are polyethylene terephthalate, copolymer of ethylene terephthalate and ethylene isophthalate, and copolymer of hexamethylene terephthalate and cyclohexanedimethylene terephthalate. For improving the sensitivity to perforation, the copolymer of ethylene terephthalate and ethylene isophthalate or the copolymer of hexamethylene terephthalate and cyclohexanedimethylene terephthalate are favorably used.

The thermoplastic resin film used according to the present invention may be doped with, if desired, an flame resist agent, a thermal stabilizer, an anti-oxidation agent, an ultraviolet absorbent, a destaticizer, a pigment, a dye, an organic lubricant such as wax or fatty acid ester, and antifoaming agent such as polysiloxane.

Moreover, the lubricating properties may be applied if necessary. The lubricating properties are given by application of, but not limited to, inorganic particles such as clay, mica, titanium dioxide, calcium carbonate, kaolin, talc, and wet and dry method silica, organic particles such as acrylic acids or styrene, built-in particles, or surfactant.

The thickness of the thermoplastic resin film used according to the present invention is preferably 0.1 to 5.0 μm and more preferably 0.1 to 3.0 μm. If the thickness exceeds 5.0 μm, the porous properties will be declined. When smaller than 0.1 μm, film forming stability or the durability to the printing action will be declined.

The porous resin layer used according to the present invention is preferably arranged to have a structure where there are a multiplicity of pores in the interior and surface thereof. More preferably, the pores are provided continuously along the thickness direction in the porous layer for ease of the passing-through of printing ink.

The average diameter of the pores in the porous resin layer ranges generally from 1 μm to 50 μm, preferably from 3 μm to 30 μm and more favorably 5 μm to 20 μm. If the average diameter is smaller than 1 μm, the passing-through of printing ink will be declined. When the printing ink has a lower level of the viscosity for improving its passing-through, it may smear or blur during the printing operation and finally the ink leaks out from both sides of the printing drum or from the trailing end of rolled heat-sensitive stencil sheet. Also, the porous resin layer will be declined in the porosity and the perforation with a thermal head will significantly be interrupted. When its average pore diameter exceeds 50 μm, the porous fiber layer will fail to retain the printing ink, thus an excess held between the printing drum and the film runs out, hence causing unwanted print through, stains or smears. Thus, both too excessive and smallish average sizes of pores can not give excellent quality of prints.

More specifically, the printing action may produce unfavorable quality of prints when the average diameter is either too large or small.

In the case of the porous resin layer is arranged with an average pore diameter of less than or equal to 20 μm, it causes the passing-through of printing ink to become difficult as layer's thickness increases. Accordingly, the transfer of printing ink to a sheet of paper to be printed will be controlled by modifying the thickness of the layer. If the layer is not uniform in the thickness, it may produce printing unevenness. The thickness should be uniform.

The thickness of the porous resin layer ranges preferably from 2 μm to 100 μm and more preferably from 5 μm to 50 μm. If thinner than 5 μm, the porous resin layer may hardly remain at behind point of pore after perforated by the thermal head and fails to control the passing-through of excess ink, thus causing back printing smears. The effect of controlling the transfer of ink is increased in proportion to the thickness of the porous resin layer. As a result, the transfer of printing ink to a sheet of paper to be printed can be controlled by modifying the thickness of the porous resin layer.

The density of the porous resin layer ranges generally from 0.01 g/cm³ to 1 g/cm³ and preferably from 0.1 g/cm³ to 0.7 g/cm³. If its density is smaller than 0.01 g/cm³, the porous resin layer will be declined in the physical strength and become destroying.

The application of the porous resin layer is 0.5 to 10.0 g/cm² and preferably 1.0 to 5.0 g/cm², from the view point of ink-transmissibility to reproduce image having solid area. If density applied is more than 10.0 g/cm², the porous resin layer may interrupt the passing-through of printing ink thus disturbing the initiation of printing. When smaller than 0.5 g/cm², the controlled transfer of ink may be much difficult.

The porous resin layer may be made from vinyl resins such as polyvinyl acetate, polyvinyl buthyral, vinyl chloride-vinyl acetate copolymer, vinyl chloride-vinylidene chloride copolymer, vinyl chloride-acrylonitryl copolymer, or styrene-acrylonitryl copolymer, polyamide such as polybutylene or nylon, and cellulose derivatives such as polyphenyl oxide, (meth)acrylic ester, polycarbonate, polyurethane, acetyl cellulose, acetylbutyl cellulose, or acetylpropyl cellulose. Alternatively, two or more different resins may be used mixed.

For adjusting the forming, the strength, and the pore size, if necessary, to the porous resin layer may be added by an additive such as a filler. The filler contemplates pigments, powder, fabrics, and the like. The filler is preferably provided in the form of needle-like configuration. Such filler may be instanced mineral needle fillers such as magnesium silicate, sepiolite, potassium titanate, wollastonite, zonotolite, or gypsum fiber, synthetic mineral needle fillers such as non-oxide needle whisker, oxide whisker, or multi-oxides whisker, and sheet fillers such as mica, glass flake, talc, and the like.

The pigment may be selected from inorganic or organic pigments, organic polymers such as polyvinyl acetate, polyvinyl chloride, or polyacrylic ethyl, zinc oxide, titan dioxide, calcium carbonate, and silica. For example, micro-capsule named as Matsumoto Microssphere (Resistered Trademark, by Matsumoto Oil and Fat Pharmacy Co., Japan) can be used effectively.

The additive may preferably be 5% by weight to 200% by weight in relation to the resin. If less than or equal to 5% by weight, the additive will hardly increase the bending rigidity. When the additive exceeds 200% by weight, the bonding to the film will be declined.

The porous resin layer may be doped with a destaticizer, stick protector, a surfactant agent, an antiseptic agent, and an antifoaming agent.

Methods of forming the porous resin layer in the heat-sensitive stencil sheet of the present invention are specified below.

The first method for forming porous resin layer involves applying and drying a liquid coating produced by dissolving and/or dispersing a resin material into a solvent mixture of a strong solvent and a poor solvent. It is necessary to have the strong solvent arranged volatile at a lower temperature than that of the poor solvent. If there is intended use of the strong and the poor solvent with one type each, the boiling point of the strong solvent has to be relatively lower than that of the poor solvent. As the strong solvent and the poor solvent are arbitrarily selected, their difference in the boiling point ranges preferably from 15 to 40° C. for forming the porous resin layer with desired properties. If the difference in the boiling point is more little than 10° C., the difference in volatility between two solvents is small enough, thus a less porous structure should be produced. When the boiling point of the poor solvent is too high, the drying takes a considerably long time, thus declining the productivity. It is hence desired that the boiling point of the poor solvent is less than or equal to 150° C.

The concentration of the resin in the liquid coating is dependent on the types of materials used, but in general ranges from 5% by weight to 30% by weight. If less than 5% by weight, the pore size will be too large or the porous resin layer will be irregular in the thickness. When the concentration exceeds 30% by weight, pores in the porous resin layer will hardly be developed, and even if the porous resin layer is developed, its pore size may be decreased thus declining the properties.

The average diameter size of pores in the porous resin layer depends significantly on the poor solvent in the surrounding atmosphere. The higher the ratio of the strong solvent causes the greater degree of aggregation of formed porous resin layer, increasing the pore average size.

The amount of the poor solvent is varied depending on the types of resin and solvent used, and has to be determined through trials. In common, the greater the dosage of the poor solvent yields the grater the pore average diameter in the porous resin layer. However, if the dosage of the poor solvent is too large, the resin itself may be separated out, making unstable coating liquid.

The second method of forming the porous resin layer is arranged by the mode as disclosed in Japanese Unexamined Patent Publication of Tokkai Hei 11-235855, in which a coating fluid of W/O type emulsion is applied and dried on a thin film. A resin (which may include additives such as a filler and an emulsifier) in the fluid coating is turned to a resultant layer structure, while water is held in pores during vaporizing of solvent, but then it is removed from the pores by successive drying, and thereby pore remains are formed, those remains make passing-through of ink.

In this method, the porous layer may be doped with desired additives such as a filler and an emulsifier for adjusting the shape, the strength, the pore diameter, and the stiffness. The filler may preferably be selected from needle, sheet, and fiber types.

For composing the W/O emulsion, an effective is a highly lipophilic surfactant having 4 to 6 of HLB (hydrophilic-lipophilic balance). The W/O emulsion may be more stable and uniform when another surfactant having 8 to 20 of HLB is mixed in the water. Alternatively, a polymer surfactant may be used for creating a stable and uniform emulsion. It is also recommendatory for creating a stable and uniform emulsion to add a dissolved thickening agent such as polyvinyl alcohol or polyacrylic acid to the aqueous emulsion.

The method of forming the porous resin layer is not limited to the above-mentioned methods.

As methods for applying the coating liquid onto the thermoplastic resin film to form the porous resin layer in accordance with the present invention, an instance may includes, but not limited to, blade, transfer roll, wire bar, reverse roll, gravure, die, and other known coating techniques.

The porous fiber layer used according to the present invention may be made from a tissue paper from of (i) mineral fibers such as glass, sepiolite, and other metals, (ii) animal fibers such as wool and silk, (iii) natural fibers such as cotton, Manila hemp, mulberry, mitsumata, and pulp, (iv) recycled fibers such as staple yarn and rayon, (v) synthetic fibers such as polyester, polyvinyl alcohol, and acryl, (vi) semi-synthetic fibers such as fiber carbon, and (vii) inorganic fibers such as whisker.

Although the size of the fabric material is necessarily determined corresponding to the perforation size and the thickness of the thermoplastic resin film, it may be less than or equal to 20 μm in diameter and preferably range from 1 to 10 μm. If the diameter is smaller than 1 μm, the tensile strength will be declined. When more than 20 μm, the passing-through of printing ink will be disturbed thus generating printing void in an image area. The length of the fabric material is preferably 0.1 to 10 mm and more preferably 1 to 6 mm. If shorter than 0.1 mm, the tensile strength will be declined. When longer than 10 mm, the dispersion will hardly be uniform.

The weight of the porous fiber layer ranges preferably from 1 to 20 g/m², preferably from 2 to 15 g/m² and more preferably 3 to 10 g/m². An amount from 1 to 20 g/m² satisfies both physical strength required transforming action and for printing durability and excellent passing-through of ink, the range from 2 to 15 g/m² improves passing-through of ink significantly, and the range from 3 to 10 g/m² causes a lesser dapples in print and an improved solid-printed area. If greater than 20 g/m², the passing-through of printing ink will be declined thus lowering the clearness of printed images. When smaller than 1 g/m², the physical strength as the supporting substrate of the layer will be declined.

The porous fiber layer may be selected from milled paper made by shorten fiber, unwoven or woven fabrics, screen gauze, and the like. The milled paper is most preferably used in view of the productivity and the cost performance.

The heat-sensitive stencil sheet according to the present invention may preferably coated with a protection layer containing silicon oil, silicon resin, fluorine resin, a surfactant, a destaticizer, a heat resistant agent, an anti-oxidization agent, organic particles, inorganic particles, a pigment, a dispersant, an antiseptic agent, and an antifoaming agent for inhibiting the film from sticking to a thermal head during the perforating. The thickness of the protection layer for inhibiting the sticking up ranges preferably from 0.005 to 0.4 μm and more preferably from 0.01 to 0.4 μm.

The method of forming the protection layer on the heat-sensitive stencil sheet of the present invention is not limited to but may be made by applying and drying a resolution of water or a solvent with the use of a roll coater, a gravure coater, a reverse coater, bar coater, and the like.

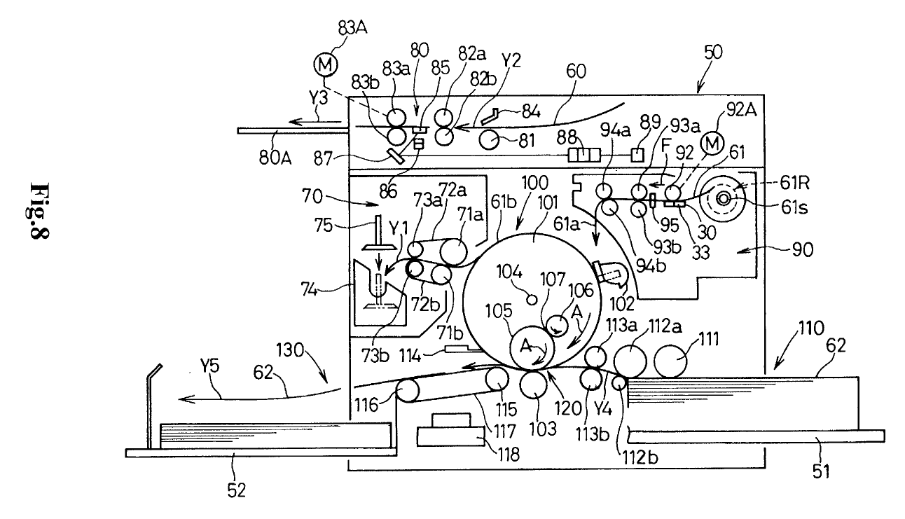

FIG. 8 illustrates a thermal stencil printing apparatus as one embodiment of the present invention. General arrangement of the thermal stencil printing apparatus and its stencil printing procedure are specified in concise referring to the drawing.

In the apparatus, lettering 50 is a main cabinet of the apparatus, at top section of the cabinet 50, original-reader part 80 is positioned. Heat-sensitive stencil sheet-loading part 90 is provided at second height section of the cabinet 50, and at the same second height section there is provided a heat-sensitive stencil master-unloading part 70. Printing drum part 100 is positioned in central area of the third height section of the cabinet 50, to which part 100 is equipped with porous printing drum 101. Paper-feeder section 110 is provided in bottom, paper-discharge section 130 is also provided.

The action of the heat-sensitive stencil sheet including structural details thereof are as follow.

Original 60 having images to be duplicated is placed on an original table (not shown) at the top of the original-reader section 80 and a stencil master fabrication-start key, which is not shown in the Figure, is pressed down. By this pressing down of the key, discharging step of used stencil master is executing. That is, at the time, stencil master 61b used in the last printing operation remains in the state being loaded on the surface of the printing drum 101 in the printing drum section 100.

As the printing drum 101 is rotated counter-clockwise, the trailing end of the used stencil master 61b, which being loaded on the printing drum 101, comes close to a pair of stencil master-unloading rollers 71a and 71b in the stencil master-unloading section 70. While the two stencil master-unloading rollers 71a and 71b are rotating, one roller 71b of those scoops up the trailing end of the used stencil master 61b, the removal of the stencil master 61b from the printing drum 101 is progressed by such manner that the stencil master 61b is gradually peeled off from the surface of the printing drum 101 and transferred by the action of an unloaded stencil master-transferring part which primarily comprises a pair of transfer belts 72a and 72b suspended between paired stencil master-unloading rollers 71 and 71b, and transfer rollers 73a and 73b. The peeled out stencil master 61b is transferred to a direction denoted by the arrow symbol Y1 and received by a box 74 for storing the used stencil master, thus its unloading step is finished, at the time, the printing drum 101 continues to rotate counter-clockwise. The used stencil master 61b is then pressed down by pressing-plate 75 in the box 74 storing the used stencil master.

In simultaneous with the unloading action, the original reader section 80 is driven for scanning the original image. Namely, the original 60 placed on the original table, which is transferred from one location denoted by arrow Y2 to another denoted by arrow Y3, by the rotating action of a separation-roller 81, a pair of front original-transfer rollers 82a and 82b, and a pair of rear original-transfer rollers 83a and 83b, while it is exposed and scanned for image reading.

When two or more of the originals 60 are piled, lowermost original is transferred at first by the action of a separation blade 84. As the rear original-transfer roller 83a is driven by an original transfer-roller motor 83A, the front original-transfer roller 82a is rotated through a timing-belt (not shown) suspended between the rear original-transfer roller 83a and the front original-transfer roller 82a. The rear original-transfer roller 83b and the front original-transfer roller 82b are driven by countered rotations of the front original-transfer roller 82a and the rear original-transfer roller 83a, respectively. The reading of data from the original 60 is implemented by beam irradiation of light, which is emitted from fluorescent lamp 86, reflected on the original 60, directed through a mirror 87 and a lens 88, and received by image sensor 89 which comprises CCD (charge coupled device) element. More particularly, the reading of data from the original 60 is carried out by a known reduction-type scanning method, and the original 60 after the reading of data is received by original tray 80A. The data is converted with an opto-electronic mode by the image sensor 89 to electric signal which is transmitted to an A/D (analog/digital) converter-circuit board, which is not shown, provided in the main cabinet 50 for producing digital image signal.

In simultaneous with the reading of data, procedures for preparing and loading the heat-sensitive stencil sheet is executed depending on the digital image signal. Spool 61s, on which the heat-sensitive stencil sheet is provided in a roll 61R form, is supported in rotation-free mode by a supporting member (not shown) provided at a location in the heat-sensitive stencil sheet-loading section 90. Heat-sensitive stencil sheet 61 is released from the roll 61R of heat-sensitive stencil sheet and transferred intermittently, towards the downstream end of a transference path for the heat-sensitive stencil sheet by the rotating action of platen roller 92, which is pressed via the heat-sensitive stencil sheet 61 toward thermal head 30, and a pair of paper-transfer rollers 93a and 93b. While the heat-sensitive stencil sheet 61 is transferring, a row of tiny heaters 33 aligned along the main scanning direction of the thermal head 30, which is selectively activated in part by the digital image signal processed and delivered from the A/D converter circuit and other controller circuits(not shown) to generate an intensity of heat and thus produce a pattern assembly of perforations in the thermoplastic resin film of the heat-sensitive stencil sheet 61. The pattern assembly of perforations produced in the heat-sensitive stencil sheet 61a by a meltdown perforating action hence represents the image data from the original. The platen roller 92 is linked by a timing-belt, which is not shown, to stencil-transferring motor 92A as driving means. The stencil-transferring motor 92A is preferably a stepping motor, which is driven continuously or intermittently. Accordingly, the heat-sensitive stencil sheet 61a is transferred at intervals of a pitch in a sub-scanning direction F, which is traversed direction to the main scanning direction, by the action of the platen roller 92 which is driven by the stencil-transferring motor 92A.

The leading end of the stencil sheet 61a having recorded image data is loaded onto the surface of the printing drum 101 by the rotating action of the two stencil-loading rollers 94a and 94b and then directed downwardly by the action of an guide member, which is also not shown, so that it hangs down towards stencil clamp 102 (denoted by the imagery line), which is provided at the loading location on the printing drum 101. By now, the used stencil master 61b has been unloaded from the printing drum 101 by the unloading action.

As the leading end of the stencil sheet 61a has been clamped at given timing by the stencil clamp 102, the printing drum 101 starts rotating in the (clockwise) direction denoted by the arrow symbol A to gradually wind up the stencil sheet 61a over its surface. The trailing end of the stencil sheet 61 is then cut to a predetermined length by cutter 95 after the loading action is finished.

As the stencil sheet 61a has been loaded at its position on the surface of the printing drum 101, the fabrication and loading of the stencil master 61 is finished and the printing is commenced. The uppermost of printing paper sheets 62 stuck on the paper-supply table 51 is picked up and advanced towards a pair of resist rollers 113a and 113b in the direction denoted by the arrow symbol Y4 by the rotating action of paper-supply roller 111, and a pair of separation-rollers 112a and 112b. The printing paper 62 is conveyed to the printing section 120 by the action of the resist rollers 113a and 113b in a defined tiring synchronized with the rotation of the printing drum 101. When the printing paper 62 driven into the position between the printing drum 101 and a press-down roller 103, it is pressed toward the stencil master 61 loaded on the printing drum 101 by the lifting action of the press-down roller 103 having been spaced from the bottom of the printing drum 101. As a result, a dose of printing ink is penetrated out from the perforations of the printing drum 101 and the perforation pattern of the stencil master 61, and the ink is transferred onto the surface of the printing paper 62 to deposit inked image as print image.

In this time, at inner side of the printing drum 101, the printing ink is fed from an ink-supply conduit 104 and stored in an ink pod 107 provided between an ink roller 105 and a doctor roller 106 in the interior of the printing drum 101 which all constitute an ink feeding means. The printing ink is spread over the inner surface of the printing drum 101, which defines periphery of cavity of the printing drum 101, by the ink roller 105 rotating along the inner side of the printing drum 101 at the same speed and direction as same of and in synchronization with the rotation of the drum 101. The printing ink may be a W/O emulsion ink.

The printing paper 62 printed with the original image at the printing section 120 is then removed from the printing drum 101 by the action of paper-removal finger 114, sucked up by the action of suction fan 118, conveyed in the direction denoted by the arrow symbol Y5 by the counter-clockwise rotating action of transfer-belt 117 suspended between paper suction-inlet roller 115 and paper suction-outlet roller 116, and discharged on discharged paper-table 52 which all are the members of the paper discharge section 130. In this manner, a trial printing procedure is carried out.

Next, a desired number of prints are determined by using the ten-key board which is not shown. When a printing-start key is pressed down, a serial steps for paper feeding, printing, and discharging printed paper, similar to the trial printing procedure, are commenced and repeated until the desired number of prints are produced, and the stencil printing is completed.

### EXAMPLES

The present invention is described in more detail in relation to but not limited to some examples below.

### Example 1

Composition A (parts by weight)

| | |
|---|---|
| Polyvinyl butyral (BHS by Sekisui Chemical) | 2.0 |
| Ethyl acetate | 18.6 |
| Sorbitan monooleate (Sorbon S80 by Toho Chemical) | 0.15 |
| Talc | 0.5 |

The above mixture was dissolved, dispersed, and gently added with 10.0 parts by weight of water (HEC(Hydorxy Ethyl Cellulose) 1% resolution) while stirred to have a white emulsion coating. The composition was coated onto a biaxially oriented polyester film of 2.0 μm thick at a temperature of 20° C. under a 50% RH atmosphere using a gravure roll so that its dry basis weight was 4.5 g/m² which was then dried and taken up as a porous resin layer in a roll form. A porous fiber layer or a sheet of 100% natural fiber milled paper (10 g/m² in basis weight and 33 μm in thickness) was coated with a one-part urethane adhesive (Takenate A260, by Takeda Chemical) at a dry amount of 0.2 g/m² using a roll coater heat up to 100° C. and then laminated with the porous resin layer of the rolled supporting substrate. The viscosity of the adhesive was about 1000 cps during coating.

An anti-sticking agent was prepared from: (in parts by weight)

| | |
|---|---|
| Silicon oil (SF8422 by Shin-etsu Chemical) | 0.5 |
| Surfactant (Prisurf A208 by Dai-ichi Kogyo) | 0.5 |
| Toluene | 100.0 |

The anti-sticking agent was applied on the side opposite to the porous resin layer side of the thermoplastic resin film using a bar coater which were then dried, taken up in a roll form, and cured at 30° C. for three days to have a heat-sensitive stencil sheet according to the present invention.

The heat-sensitive stencil sheet was examined by the above described evaluation method. Its resulted shown as in Table 1.

### Example 2

Another heat-sensitive stencil sheet according to the present invention was fabricated by the same manner as of Example 1, except that the porous fiber layer was a milled paper mixture of hemp and polyester fiber (9.0 g/m² in basis weight and 35 μm in thickness) and the amount of the adhesive was 0.7 g/m². Its evaluation resulted shown also as in Table 1.

### Example 3

Composition B (parts by weight)

| | |
|---|---|
| Acetal resin (KS-1 by Sekisui Chemical) | 2.5 |
| Talc | 1.9 |
| Surfactant (SO15U by Nikko Checmical) | 0.1 |
| Surfactant (KF6012 by Shin-etsu Checmical) | 0.1 |
| Surfactant (J711 by Johnson) | 0.2 |
| Ethyl acetate | 43.0 |

The above mixture was dissolved, dispersed, and gently added with 20.0 parts by weight of water (HEC 1% resolution) while stirred to have a white emulsion coating. The coating was applied onto a biaxially oriented polyester film of 2.0 μm thick at a temperature of 20° C. under a 50% RH atmosphere using a gravure roll so that its dry basis weight was 2.0 g/m² which were then dried and taken up as a porous resin layer in a roll. Separately, a porous fiber layer or a sheet of 100% natural fiber milled paper (10 g/m² in basis weight and 33 μm in thickness) was coated with a one-part urethane adhesive (Takenate A260 by Takeda Chemical) at an amount of 1.3 g/m² using a roll coater heated up to 100° C. and then laminated with the porous resin layer of the rolled supporting substrate. The viscosity of the adhesive was about 1000 cps during coating. The same procedure as of Example 1 was followed to have a heat-sensitive stencil sheet according to the present invention.

### Example 4

A further heat-sensitive stencil sheet according to the present invention was fabricated by the same manner as of Example 3, except that the adhesive was a two-part urethane adhesive (Takelac A230 as polyol and A30 as isocyanate at a mixing ratio of 10:8 by Takeda Chemical) applied to an amount of 0.7 g/m² with the use of a roll coater heated to 70° C. The viscosity of the adhesive was about 800 cps during coating. Its evaluation resulted as shown in Table 1.

### Example 5

Composition B (parts by weight)

| | |
|---|---|
| Acetal resin (KS-1 by Sekisui Chemical) | 2.5 |
| Talc | 1.9 |
| Surfactant (SO15U by Nikko Checmical) | 0.1 |
| Surfactant (KF6012 by Shin-etsu Checmical) | 0.1 |
| Surfactant (J711 by Johnson) | 0.2 |
| Ethyl acetate | 43.0 |

The above mixture was dissolved, dispersed, and gently added with 20.0 parts by weight of water (HEC 1% resolution) while stirred to have a white emulsion coating. The coating was applied onto a biaxially oriented polyester film of 2.0 μm thick at a temperature of 20° C. under a 50% RH atmosphere using a gravure roll so that its dry basis weight was 2.0 g/m² which were then dried and taken up as a porous resin layer in a roll.

An ionizing radiation-curable adhesive having a viscosity of 1300 cps at 80° C. was prepared by fusion mixing at 80° C. of: (parts by weight)

| | |
|---|---|
| Polyurethane acrylate resin (Beamset 504H by Arakawa Chemical) | 70.0 |
| Acrylic ester monomer (Aronics M-101 by Toa Gosei) | 30.0 |

Then, a porous fiber layer or a sheet of 100% natural fiber milled paper (10 g/m² in basis weight and 33 μm in thickness) was coated at one side with the ionizing radiation-curable adhesive at an amount of 0.7 g/m² using a roll coater heated up to 80° C. and then laminated with the porous resin layer of the rolled supporting substrate. A resultant assembly was exposed to 5 M rad. of electron beam and coated at the side opposite to the porous resin layer side of the thermoplastic resin film with the same anti-sticking agent as of Example 1 using a bar coater, which were then dried and taken up in a roll to have a heat-sensitive stencil sheet according to the present invention.

### Example 6

Composition C (parts by weight)

| | |
|---|---|
| Acetal resin (KS-1 by Sekisui Chemical) | 2.5 |
| Talc | 0.8 |
| Surfactant (SO15U by Nikko Checmical) | 0.1 |
| Surfactant (KF6012 by Shin-etsu Checmical) | 0.1 |
| Surfactant (J711 by Johnson) | 0.2 |
| Ethyl acetate | 43.0 |

The above mixture was dissolved, dispersed, and gently added with 20.0 parts by weight of water (HEC 1% resolution) while stirred to have a white emulsion coating. The coating was applied onto a biaxially oriented polyester film of 2.0 μm thick at a temperature of 20° C. under a 50% RH atmosphere using a gravure roll so that its dry basis weight was 5.0 g/m² which were then dried and taken up as a porous resin layer in a roll.

The same procedure as of Example 5 was followed to have a further heat-sensitive stencil sheet according to the present invention, except that the porous fiber layer was a milled paper of two different polyester fibers at 0.2 denier and 1.1 deniers (8 g/m² in basis weight and 25 μm in thickness) and the amount of the adhesive was 0.2 g/m². Its evaluation result also is shown in Table 1.

### Example 7

An ionizing radiation-curable adhesive having a viscosity of 500 cps at 40° C was prepared by fusion mixing at about 40° C. of: (parts by weight)

| | |
|---|---|
| Polyurethane acrylate resin (Beamset 510 by Arakawa Chemical) | 68.0 |
| Photo polymeric monomer (Dalocure 1173 by Merck (Japan) | 2.0 |
| Acrylic ester monomer (Aronics M-101 by Toa Gosei) | 30.0 |

Then, a porous fiber layer or a sheet of 100% natural fiber milled paper (10 g/m² in basis weight and 33 μm in thickness) was coated at one side with the ionizing radiation-curable adhesive at an amount of 0.5 g/m² using a roll coater heated up to 40° C. and then laminated with the porous resin layer of the rolled supporting substrate of Example 1. A resultant assembly was exposed to ultraviolet light emitted from a 60 w/cm metal halide lamp and coated at the side opposite to the porous resin layer side of the thermoplastic resin film with the same anti-sticking agent as of Example 1 using a bar coater, which were then dried and taken up in a roll to have a heat-sensitive stencil sheet according to the present invention. Its evaluation result is shown in Table 1.

### Example 8

A further heat-sensitive stencil sheet according to the present invention was fabricated by the same manner as of Example 5, except that the amount of the adhesive for bonding between the porous resin layer and the porous fiber layer was 0.07 g/m². Its evaluation resulted as also shown in Table 1.

### Example 9

Composition D (Parts by Weight)

A further heat-sensitive stencil sheet according to the present invention was fabricated as below and examined.

| | |
|---|---|
| Acetal resin (KS-1 by Sekisui Chemical) | 1.5 |
| Acetal resin (KS- by Sekisui Chemical) | 1.0 |
| Talc | 1.9 |
| Surfactant (SO15U by Nikko Checmical) | 0.1 |
| Surfactant (KF6012 by Shin-etsu Checmical) | 0.1 |
| Surfactant (J711 by Johnson) | 0.2 |
| Ethyl acetate | 43.0 |

The above mixture was dissolved, dispersed, and gently added with 20.0 parts by weight of water (HEC 1% resolution) while stirred to have a white emulsion coating. The coating was applied onto a biaxially oriented polyester film of 2.0 μm thick at a temperature of 20° C. under a 50% RH atmosphere by die coating method so that its dry basis weight was 2.5 g/m² which were then dried and taken up as a porous resin layer in a roll.

As porous fiber layer, used was a milled paper of two different polyester fibers at 0.2 denier and 1.1 deniers (5 g/m² in basis weight and 21 μm in thickness), and the adhesive was 0.2 g/m² after dried. Result is shown in Table 1.

### Example 10

A further heat-sensitive stencil sheet according to the present invention was fabricated by the same manner as of Example 9, with exception that the used paper was of olyester fiber at 0.2 denier (3.5 g/m² in basis weight and 18 μm in thickness), and made by heat pressing. Its evaluation resulted as also shown in Table 1.

### Example 11

A further heat-sensitive stencil sheet according to the present invention was fabricated by the same manner as of Example 9, with exception that used paper was of 7.5 g/m² in basis weight. Its evaluation resulted as also shown in Table 1.

### Example 12

A further heat-sensitive stencil sheet according to the present invention was fabricated by the same manner as of Example 9, with exception that the paper made of the mixture of hemp fiber and polyester fiber at 0.2 denier (13.0 g/m² in basis weight and 51 μm in thickness) and the amount of the adhesive after dried was 0.3 g/m². Its evaluation resulted as also shown in Table 1.

### Example 13

A further heat-sensitive stencil sheet according to the present invention was fabricated by the same manner as of Example 9, with exception that used paper was of the adhesive was 1.0 g/m² after dried. Its evaluation resulted as also shown in Table 1.

### Comparative Example 1

A porous fiber layer or a sheet of 100% natural fiber milled paper (10 g/m² in basis weight and 33 μm in thickness) was coated with a one-part urethane adhesive (Takenate A260 by Takeda Chemical) at an amount of 0.2 g/m² using a roll coater heated up to 100° C. and then laminated with the thermoplastic resin film of 2.0 μm thick identical to that of Example 1. The viscosity of the adhesive was about 1000 cps during coating.

An anti-sticking agent was prepared from: (parts by weight)

| | |
|---|---|
| Silicon oil (SF8422 by Shin-etsu Chemical) | 0.5 |
| Surfactant (Prisurf A208 by Daiichi Kogyo) | 0.5 |
| Toluene | 100.0 |

The anti-sticking agent was applied to the side opposite to the porous resin layer side of the thermoplastic resin film which were dried, taken up in a roll, and cured at 30° C. for three days to have a heat-sensitive stencil sheet.

### Comparative Example 2

A heat-sensitive stencil sheet was fabricated by the same manner as of Comparative Example 1, except that the porous fiber layer was a milled paper sheet of two different polyester fibers at 0.2 denier and 1.1 deniers (8 g/m² in basis weight and 25 μm in thickness).

### Comparative Example 3

Composition A (parts by weight)

| | |
|---|---|
| Polyvinyl butyral (BHS by Sekisui Chemical) | 2.0 |
| Ethyl acetate | 18.6 |
| Sorbitan monooleate (Sorbon S80 by Toho Chemical) | 0.15 |
| Talc | 0.5 |

The above mixture was dissolved, dispersed, and gently added with 10.0 parts by weight of water (HEC 1% resolution) while stirred to have a white emulsion coating. The coating was applied onto a biaxially oriented polyester film of 2.0 μm thick at a temperature of 20° C. under a 50% RH atmosphere using a gravure roll so that its dry basis weight was 4.5 g/m² which were then dried and taken up as a porous resin layer in a roll.

An anti-sticking agent was prepared from: (in parts by weight)

| | |
|---|---|
| Silicon oil (SF8422 by Shin-etsu Chemical) | 0.5 |
| Surfactant (Prisurf A208 by Daiichi Kogyo) | 0.5 |
| Toluene | 100.0 |

The anti-sticking agent was applied on the side opposite to the porous resin layer side of the thermoplastic resin film using a bar coater which were then dried and taken up to have a heat-sensitive stencil sheet. Its evaluation result is shown in Table 1.

### Comparative Example 4

Composition B (parts by weight)

| | |
|---|---|
| Acetal resin (KS-1 by Sekisui Chemical) | 2.5 |
| Talc | 1.9 |
| Surfactant (SO15U by Nikko Checmical) | 0.1 |
| Surfactant (KF6012 by Shin-etsu Checmical) | 0.1 |
| Surfactant (J711 by Johnson) | 0.2 |
| Ethyl acetate | 43.0 |

The above mixture was dissolved, dispersed, and gently added with 20.0 parts by weight of water (HEC 1% resolution) while stirred to have a white emulsion coating. The coating was applied onto a biaxially oriented polyester film of 2.0 μm thick at a temperature of 20° C. under a 50% RH atmosphere using a gravure roll so that its dry basis weight was 2.0 g/m² which were then dried and taken up as a porous resin layer in a roll.

A liquid mixture coating was prepared by fusion mixing of: (parts by weight)

| | |
|---|---|
| Saturated polyester adhesive (UE3500 by Unitika) | 15.0 |
| Toluene | 75.0 |

A sheet of 100% natural fiber milled paper (10 g/m² in basis weight and 33 μm in thickness) was coated with the mixture coating at a dry basis weight of 0.2 g/m² using a direct gravure coater, bonded with the porous resin layer of the rolled supporting substrate, and dried at 50° C.

An anti-sticking agent was prepared from: (parts by weight)

| | |
|---|---|
| Silicon oil (SF8422 by Shin-etsu Chemical) | 0.5 |
| Surfactant (Prisurf A208 by Daiichi Kogyo) | 0.5 |
| Toluene | 100.0 |

The anti-sticking agent was applied on the side opposite to the porous resin layer side of the thermoplastic resin film using a bar coater which were then dried and taken up to have a heat-sensitive stencil sheet. Its evaluation result is shown in Table 1.

### Comparative Example 5

A liquid mixture coating was prepared from: (parts by weight)

| | |
|---|---|
| Polyethylene emulsion adhesive (PN-200 by Saiden Chemical) | 100.0 |

A sheet of 100% natural fiber milled paper (10 g/m² in basis weight and 33 μm in thickness) was coated with the mixture coating at a dry amount of 1.0 g/m² using a direct gravure coater, half-dried at 50° C., bonded with the porous resin layer of the rolled supporting substrate of Comparative Example 4, and fully dried at 50° C.

An anti-sticking agent was prepared from: (parts by weight)

| | |
|---|---|
| Silicon oil (SF8422 by Shin-etsu Chemical) | 0.5 |
| Surfactant (Prisurf A208 by Daiichi Kogyo) | 0.5 |
| Toluene | 100.0 |

The anti-sticking agent was applied on the side opposite to the porous resin layer side of the thermoplastic resin film using a bar coater which were then dried and taken up to have a heat-sensitive stencil sheet. Its evaluation result is shown in Table 1.

### Comparative Example 6

A heat-sensitive stencil sheet was fabricated by the same manner as of Comparative Example 5, except that the amount of the adhesive was 2.5 g/m². Its evaluation result is shown in Table 1.

### Comparative Example 7

A heat-sensitive stencil sheet was fabricated by the same manner as of Example 5, except that the amount of the adhesive for bonding between the porous resin layer and the porous fiber layer was 1.60 g/m². Its evaluation result is shown in Table 1.

### Comparative Example 8

A heat-sensitive stencil sheet was fabricated by the same manner as of Example 13, except that the amount of the porous resin layer after dried was 0.3 g/m². Its evaluation result is shown in Table 1.

### Comparative Example 9

A heat-sensitive stencil sheet was fabricated by the same manner as of Example 12, except that the amount of the porous fiber layer was 16.0 g/m². Its evaluation result is shown in Table 1.

(Evaluation for Characteristics)

1) Evaluation for Print Quality

Each of the heat-sensitive stencil sheets was loaded to a commercial printer, Preport JP4000 (Resisterd Trademarke by Ricoh Corp., Ltd., adopted with thermal head of resolution degree of 400 dpi), processed by a thermal head perforation technique, and subjected to a printing action with an original having a solid black portion, 50 mm×50 mm. The printing was repeated at the rate of 100 cycles per minute, approximately. Moreover than 100 prints by each heat-sensitive stencil sheet were printed to provide for naked eye examination and evaluated, as Prints having Outstanding blanks in the solid black portion are presented by Mark ×, Prints having no print-through are presented by Mark O, prints having

quality to be laid between O and × and applicable in practice are presented by Mark Δ.

2) Evaluation for Durability in Printing

Each of the heat-sensitive stencil sheets were loaded to a commercial printer, Preport JP4000 by Ricoh, processed by a thermal head perforation technique, and subjected to a printing action with an original having a solid black portion, 50 mm×50 mm, and 6-point letters. The printing was conducted at a standard speed. The number of prints was counted when the peeling off of the film or the separation between the porous resin layer and the porous fiber layer developed a printing fault such as image extension.

3) Evaluation for Transfer

During the above two steps 1) and 2), the evaluation was made O when the heat-sensitive stencil sheet was transferred with no trouble, × when the heat-sensitive stencil sheet generated wrinkles, and Δ when the heat-sensitive stencil sheet generated wrinkles but its print exhibited no fault.

TABLE 1-1

| | heat-sensitive stencil sheet composition | | | | | |
|---|---|---|---|---|---|---|
| | | | | pourous fiber layer | | |
| | film | porous resin layer | | | basis | |
| | thickness | | amount | | weight | thickness |
| | (μm) | composition | (g/m²) | material | (g/m²) | (μm) |
| Ex. 1 | 2.0 | A | 4.5 | natural fiber | 10 | 33 |
| | | | | 100% | | |
| Ex. 2 | 2.0 | A | 4.5 | mixed fibers | 9 | 35 |
| Ex. 3 | 2.0 | B | 2.0 | natural fiber | 10 | 33 |
| | | | | 100% | | |
| Ex. 4 | 2.0 | B | 2.0 | natural fiber | 10 | 33 |
| | | | | 100% | | |
| Ex. 5 | 2.0 | B | 2.0 | natural fiber | 10 | 33 |
| | | | | 100% | | |
| Ex. 6 | 2.0 | C | 5.0 | synthetic | 8 | 25 |
| | | | | fiber 100% | | |
| Ex. 7 | 2.0 | A | 4.5 | natural fiber | 10 | 33 |
| | | | | 100% | | |
| Ex. 8 | 2.0 | B | 2.0 | natural fiber | 10 | 33 |
| | | | | 100% | | |
| Ex. 9 | 2.0 | D | 2.5 | synthetic | 5 | 21 |
| | | | | fiber 100% | | |
| Ex. 10 | 2.0 | D | 2.5 | synthetic | 3.5 | 18 |
| | | | | fiber 100% | | |
| Ex. 11 | 2.0 | D | 7.5 | synthetic | 5 | 21 |
| | | | | fiber 100% | | |
| Ex. 12 | 2.0 | D | 2.5 | mixed fibers | 13 | 51 |
| Ex. 13 | 2.0 | D | 1.0 | synthetic | 5 | 21 |
| | | | | fiber 100% | | |
| Com. Ex. 1 | 2.0 | — | — | natural fiber | 10 | 33 |
| | | | | 100% | | |
| Com. Ex. 2 | 2.0 | — | — | mixed | 8 | 25 |
| | | | | polyester | | |
| | | | | fibers | | |
| Com. Ex. 3 | 2.0 | A | 4.5 | — | — | — |
| Com. Ex. 4 | 2.0 | B | 2.0 | natural fiber | 10 | 33 |
| | | | | 100% | | |
| Com. Ex. 5 | 2.0 | B | 2.0 | natural fiber | 10 | 33 |
| | | | | 100% | | |
| Com. Ex. 6 | 2.0 | B | 2.0 | natural fiber | 10 | 33 |
| | | | | 100% | | |
| Com. Ex. 7 | 2.0 | B | 2.0 | natural fiber | 10 | 33 |
| | | | | 100% | | |
| Com. Ex. 8 | 2.0 | D | 0.3 | synthetic | 5 | 21 |
| | | | | fiber 100% | | |
| Com. Ex. 9 | 2.0 | D | 2.5 | mixed fibers | 16 | 55 |

TABLE 1-2

| | adhesive | | |
|---|---|---|---|
| | | viscosity at | amount |
| | type | coating | (g/m²) |
| Ex. 1 | composed elements type | 1000 cps at 100° C. | 0.20 |
| Ex. 2 | composed elements type | 1000 cps at 100° C. | 0.70 |
| Ex. 3 | composed elements type | 1000 cps at 100° C. | 1.30 |
| Ex. 4 | separated element type | 800 cps at 75° C. | 0.70 |
| Ex. 5 | electron curable | 1300 cps at 80° C. | 0.70 |
| Ex. 6 | electron curable | 1300 cps at 80° C. | 0.20 |
| Ex. 7 | ultraviolet curable | 500 cps at 40° C. | 0.50 |
| Ex. 8 | electron curable | 1300 cps at 80° C. | 0.07 |
| Ex. 9 | electron curable | 1300 cps at 80° C. | 0.20 |
| Ex. 10 | electron curable | 1300 cps at 80° C. | 0.20 |
| Ex. 11 | electron curable | 1300 cps at 80° C. | 0.20 |
| Ex. 12 | electron curable | 1300 cps at 80° C. | 0.30 |
| Ex. 13 | electron curable | 1300 cps at 80° C. | 0.20 |
| Com. Ex. 1 | composed elements type | 1000 cps at 100° C. | 0.20 |
| Com. Ex. 2 | composed elements type | 1000 cps at 100° C. | 0.20 |
| Com. Ex. 3 | — | — | — |
| Com. Ex. 4 | saturated polyester | diluted by totuene | 0.20 |
| Com. Ex. 5 | polyethylene | diluted by water | 1.00 |
| Com. Ex. 6 | polyethylene | diluted by water | 2.50 |
| Com. Ex. 7 | electron curable | 1300 cps at 80° C. | 1.60 |
| Com. Ex. 8 | electron curable | 1300 cps at 80° C. | 0.20 |
| Com. Ex. 9 | electron curable | 1300 cps at 80° C. | 0.30 |

TABLE 1-3

| | result of evaluation | | | | | |
|---|---|---|---|---|---|---|
| | | | printed quality | | | |
| | bonding strength* | | solid | print- | printing | conveying |
| | F-P | P-W | black | through | durability | smoothness |
| Ex. 1 | 3.2 N/m | 7.6 N/m | ∘ | ∘ | over 5000 | ∘ |
| Ex. 2 | 3.2 N/m | 23.2 N/m | ∘ | ∘ | over 5000 | ∘ |
| Ex. 3 | 2.0 N/m | 35.6 N/m | Δ | ∘ | over 5000 | ∘ |
| Ex. 4 | 2.0 N/m | 18.4 N/m | ∘ | ∘ | over 5000 | ∘ |
| Ex. 5 | 2.0 N/m | 16.0 N/m | ∘ | ∘ | over 5000 | ∘ |
| Ex. 6 | 8.0 N/m | 5.2 N/m | ∘ | ∘ | over 5000 | ∘ |
| Ex. 7 | 3.2 N/m | 1.2 N/m | ∘ | ∘ | over 5000 | Δ |
| Ex. 8 | 2.0 N/m | 0.9 N/m | ∘ | ∘ | over 5000 | Δ |
| Ex. 9 | 2.5 N/m | 7.6 N/m | ∘ | ∘ | over 5000 | ∘ |
| Ex. 10 | 2.5 N/m | 6.4 N/m | ∘ | ∘ | over 5000 | ∘ |
| Ex. 11 | 2.7 N/m | 6.6 N/m | Δ | ∘ | over 5000 | ∘ |
| Ex. 12 | 2.5 N/m | 8.4 N/m | Δ | ∘ | over 5000 | ∘ |
| Ex. 13 | 2.5 N/m | 9.3 N/m | ∘ | Δ | over 5000 | ∘ |
| Com. Ex. 1 | 8.4 N/m | — | x | x | stretched by | ∘ |
| | | | | | 3000 | |
| Com. Ex. 2 | 9.2 N/m | — | Δ | x | stretched by | ∘ |
| | | | | | 4000 | |
| Com. Ex. 3 | 3.2 N/m | — | ∘ | ∘ | stretched by | x |
| | | | | | 2000 | |
| Com. Ex. 4 | 2.0 N/m | 0.4 N/m | x | ∘ | peeled by | x |
| | | | | | 500 | |
| Com. Ex. 5 | 2.0 N/m | 0.3 N/m | Δ | ∘ | peeled by | x |
| | | | | | 300 | |
| Com. Ex. 6 | 2.0 N/m | 1.6 N/m | x | ∘ | over 5000 | Δ |
| Com. Ex. 7 | 2.0 N/m | 36.6 N/m | x | ∘ | over 5000 | ∘ |
| Com. Ex. 8 | 2.3 N/m | 9.2 N/m | ∘ | x | over 5000 | ∘ |
| Com. Ex. 9 | 2.5 N/m | 8.5 N/m | x | ∘ | over 5000 | ∘ |

*The bonding strength in Comparative Examples 1 and 2 is measured between the thermoplastic resin film and the porous fiber layer.
F-P represents the bonding strength between the film and the porous resin layer while P-W represents the bonding strength between the porous resin layer and the porous fiber layer.

As apparent from the foregoing detailed and specified description, the heat-sensitive stencil sheet of the present invention has a porous resin layer of a resin material provided on one side of a thermoplastic resin film and a porous fiber layer of a fiber material provided on the porous resin layer and is characterized in that the porous resin layer and the porous fiber layer are bonded at an optimum bonding strength to each other by a minimum amount of a curable adhesive which incorporates a supporting substrate for inhibiting the heat-sensitive stencil sheet from being expanded or fractured during the printing. Accordingly, the heat-sensitive stencil sheet and its fabricating method can be improved where resultant prints exhibits no printing unevenness at a less amount of printing ink and less fouling on their back.

What is claimed is:

1. A heat-sensitive stencil sheet having a porous resin layer provided on one side of a thermoplastic resin film, and a porous fiber layer bonded by an adhesive to the surface of the porous resin layer, wherein the amount of the adhesive ranges from 0.05 g/m² to 1.5 g/m², and the bonding strength between the porous resin layer and the porous fiber layer ranges from 0.8 N/m to 50.0 N/m.

2. A heat-sensitive stencil sheet according to claim 1, wherein the adhesive is a primarily urethane adhesive of moisture-curable type.

3. A heat-sensitive stencil sheet according to claim 1 or claim 2, wherein the adhesive is a primarily adhesive of ionizing radiation-curable type.

4. A heat-sensitive stencil sheet according to claim 1, wherein the amount of the porous resin layer ranges from 0.5 g/m² to 10.0 g/m² by dry basis.

5. A heat-sensitive stencil sheet according to claim 1, wherein the amount of the porous resin layer ranges from 1.0 g/m² to 5.0 g/m² by dry basis.

6. A heat-sensitive stencil sheet according to claim 1, wherein the porous resin layer is a foamy film formed by applying a fluid containing an resin emulsion of water in oil type onto a thermoplastic film and drying it.

7. A heat-sensitive stencil sheet according to claim 1, wherein amount of the porous fiber layer ranges from 1.0 g/m² to 15.0 g/m².

8. A heat-sensitive stencil sheet according to claim 1, wherein the amount of the porous fiber layer ranges from 3.0 g/m² to 10.0 g/m².

9. A method for fabricating a heat-sensitive stencil sheet according to claim 1 comprising the steps of; applying a coating liquid to one side of a thermoplastic film to form a porous resin layer attached to the thermoplastic film; and after at least the outermost surface of the porous resin layer is dried and cured, bonding the porous resin layer to a porous fiber layer coated with a adhesive.

10. A thermal stencil printing apparatus loaded with a perforated heat-sensitive stencil master produced from a heat-sensitive stencil sheet, wherein the heat-sensitive stencil sheet is one as claimed in claim 1.
